(19) United States
(12) Patent Application Publication
(10) Pub. No.: US 2023/0162040 A1
(43) Pub. Date: May 25, 2023

(54) CUSTOM MODELS FOR SOURCE CODE GENERATION

(71) Applicant: MICROSOFT TECHNOLOGY LICENSING, LLC., REDMOND, WA (US)

(72) Inventors: COLIN BRUCE CLEMENT, SEATTLE, WA (US); NEELAKANTAN SUNDARESAN, BELLEVUE, WA (US); ALEXEY SVYATKOVSKIY, BELLEVUE, WA (US); MICHELE TUFANO, BELLEVUE, WA (US); ANDREI ZLOTCHEVSKI, BROSSARD (CA)

(21) Appl. No.: 17/535,380

(22) Filed: Nov. 24, 2021

(51) Int. Cl. G06N 3/08; G06N 3/04; G06F 8/35

(52) U.S. Cl. CPC G06N 3/084; G06N 3/04; G06F 8/35

(57) ABSTRACT

Custom source code generation models are generated by fine-tuning a pre-trained neural transformer model with a particular strategy for updating select parameters of the pre-trained neural transformer model. The fine-tuning process is distributed across a user space and a model space where the embedding and output layers are performed in the user space and the execution of the model is performed in a model space that is isolated from the user space. The fine-tuning process updates the select parameters of the pre-trained model across the separate execution spaces in a manner that preserves the privacy of the data used in the fine-tuning process.

### BACKGROUND

Deep learning models are used often to solve a variety of problems. Deep learning models employ neural networks that are trained to learn to recognize patterns and make predictions from generalizing the learned patterns. One drawback of these models is the extensive amount of time and resources needed to train a deep learning model. A model may require a training dataset of real-world data consisting of several million data samples mined from various sources. The training itself may take days to weeks of computing time to train the model. Neural networks are trained iteratively, making multiple passes over the training dataset before converging to a minimum. The training is iterative and the entire training dataset is passed through the neural network in multiple iterations to find the hyperparameters (e.g., model architecture, vocabulary encoding procedures, training objective, data normalization) that meet a target objective.

In order to reduce the training time and cost in developing a deep learning model, fine-tuning is often utilized to generate a model tailored for a related task. However, in some situations, it may not be possible to fine-tune a pre-trained model when the fine-tuning data includes private or sensitive data that should not be disclosed. A privacy threat can occur at any stage of the development of the model and its usage. The fine-tuning dataset and predictions can be a target of privacy attacks leading to sensitive information leakage.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Custom source code generation models are generated by fine-tuning a pre-trained deep learning model with a particular strategy for updating the parameters of the pre-trained deep learning model. The pre-trained deep learning model is trained to predict or generate source code given a context. The custom model is fine-tuned to generate source code for a related task using a fine-tuning dataset.

The fine-tuning process is distributed across a user space and a model space where the embedding and output layers are executed in the user space and the tuning of the model is performed in a model space. The model space and the user space are in separate execution environments that do not share computing resources. The fine-tuning process updates the select parameters of the pre-trained model across the separate execution spaces in a manner that preserves the privacy of the data used in the fine-tuning process.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary system for generating custom models for source code generation in separate execution environments.

FIG. 2 is a schematic diagram illustrating an exemplary architecture of an encoder-decoder neural transformer model with attention.

FIG. 3 is a flow diagram illustrating an exemplary method for generating a custom model.

FIG. 4 is a block diagram illustrating an exemplary operating environment.

### DETAILED DESCRIPTION

Overview

Various approaches are disclosed for generating custom deep learning models that perform source code generation tasks. Deep learning models are used for various types of source code generation tasks, such as, without limitation, generating source snippets from natural language descriptions, generating unit test cases from a focal source code method under test, and generating source code repair patches from buggy source code. The models are pre-trained on a large corpus of source code and/or natural language code summaries from publicly available source code repositories and then fine-tuned on a specific related task. Fine-tuning the pre-trained model on the related task produces a custom model tailored for the related task.

Customization pertains to the process of fine-tuning a deep learning model M, previously trained on a generic dataset for a task t, with the goal of improving its performance on a specific custom dataset p. The performance of the model M on custom dataset p can be measured by one or more evaluation functions, such as ƒ(M, p), where ƒ can be a maximization function, such as the Bilingual Evaluation Understudy (BLEU) quality metric score or a minimization function, such as the minimization of a cross-entropy loss function. The customization process is designed to modify the parameters of the model M, obtaining the model M′, such that the performance of M′ on p is improved over M. Specifically, ƒ(M′, p)>ƒ(M, p) for maximization functions or ƒ(M, p)<ƒ(M, p) for minimization functions.

In one aspect, the deep learning model is a neural transformer model with attention. Deep learning models differ from traditional machine learning models. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, support vector machines, and visual data mapping. Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks.

A neural transformer model with attention is one type of deep learning that utilizes an attention mechanism. Attention directs the neural network to focus on a subset of features or tokens in an input sequence thereby learning different representations from the different positions of the tokens in an input sequence. The attention mechanism provides the model with a better capability to learn the task at hand thereby generating more accurate predictions. It should be noted that the term neural transformer model with attention and neural transformer model are used interchangeably.

There are different configurations of a neural transformer model. In one aspect, the customization techniques are applied to an encoder-decoder configuration of a neural transformer model. The encoder-decoder neural transformer model is used for machine translation tasks (i.e., sequence-to-sequence task) that translate an input sequence of one domain into an output sequence of a second domain, where a domain is a specific field or subject. A machine translation model learns a function that translates an input sequence into an output sequence.

In the context of code generation, the encoder-decoder neural transformer model is trained to translate a source code snippet of a first domain into a source code snippet of a second domain. A source code snippet includes various portions of source code as well as a docstring contained therein. For example, a model may be trained to translate a method signature (first domain) into a documentation string (second domain) for the method signature, translate a method signature (first domain) into a corresponding method body (second domain), translate a documentation string for a method (first domain) into the source code of the method body (second domain), translate a method body (first domain) into a method signature (second domain), translate a documentation string for a method body (first domain) into a method signature (second domain), translate a buggy source code snippet (first domain) into a repair patch for the buggy source code (second domain), and so forth.

The customization of a pre-trained model allows for the transfer of the parameters (e.g., weights and biases) from the pre-trained model for discriminative fine tuning on specific tasks. There are different fine-tuning approaches offering different trade-offs in the total computational cost and the prediction performance. For example, in order to mitigate the costs in fine-tuning a pre-trained model, the number of parameters that are modified can be adjusted to accommodate the needs of a task. This results in various customization strategies that include custom fine-tuning, lightweight fine-tuning of embeddings and the output layer (L-EO), and lightweight fine-tuning of the last decoder block (L-LDB). An advantage of lightweight fine-tuning is that only a limited number of parameters is changed during the customization process. The fine-tuned model consumes significantly less storage compared with the full customization approach where the entire model's parameters are changed. Similarly, the inference process consumes less memory when serving multiple users since only a limited number of user-specific parameters are required for each user.

In custom fine-tuning, the pre-trained neural transformer model is trained on a particular task with all parameters from the encoder and decoder blocks, the parameters in the output layer, and the embeddings modified. In L-EO customization, the embeddings and the model's output layer are fine-tuned while the parameters in the encoder and decoder blocks are kept frozen.

With L-LDB customization, only the parameters in the last decoder block are trainable with all other parameters kept frozen. Experimental results have shown that the highest changes in parameter values occur in the last decoder block. Hence, tuning the parameters of the last decoder block may be sufficient to obtain performance improvements similar to a fully-customized model and beneficial for situations where computing resources are limited.

Data privacy is a challenge and risk associated with the development of a deep learning model and its usage. In some situations, the model is provided by a third-party web service that fine-tunes the model with training data from a customer. The customer may be reluctant to disclose the raw data of the training data and the output predictions. The training dataset and the prediction results may be inadvertently released during the training stage of a model or in the inference stage. In order to account for this privacy risk, a portion of the training process is performed in a user space and another portion of the training process is performed in a model space. The user space and the model space are in different execution environments. The model space has no access to the raw user data of the training dataset and prediction results in order to prevent the inadvertent disclosure of the private data contained therein.

Attention now turns to a more detailed description of the system, components, and methods for generating and deploying custom models for source code generation.

System

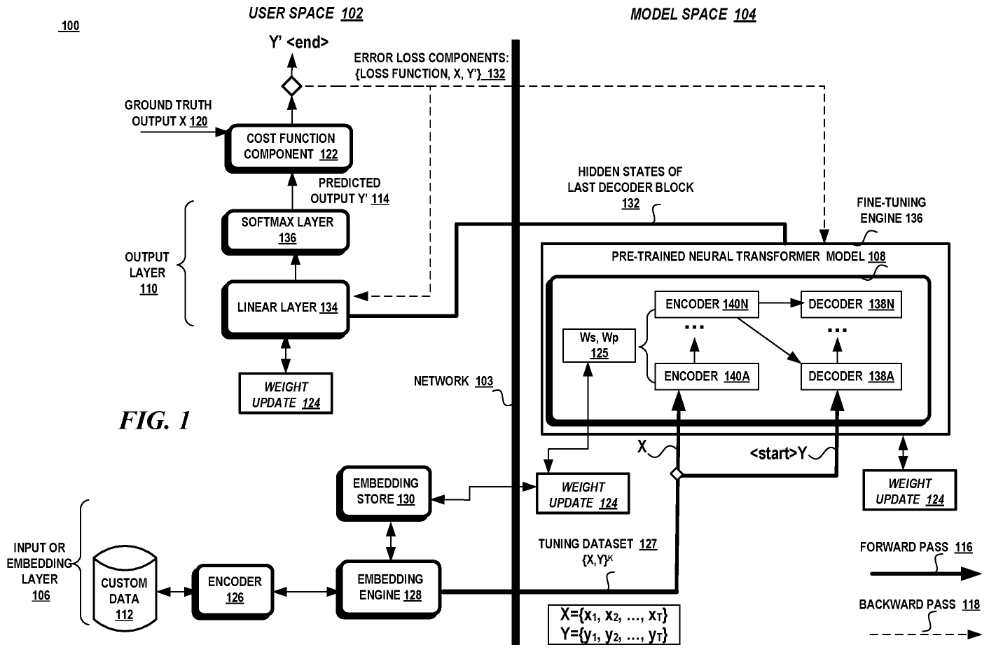

Turning to FIG. 1, there is shown an exemplary configuration of a system 100 for generating custom models for source code generation. The system 100 is described with respect to training a sequence-to-sequence neural transformer model with attention. It should be understood that the techniques described herein are not limited to this particular type of model and that the techniques may be applied to other configurations of a neural transformer model with attention and other types of deep learning models.

The system 100 is configured with an input or embedding layer 106 executed in a user space 102, the model 108 executed in a model space 104, and the output or head layer 110 executed in the user space 102. In this configuration, the raw custom data 112 is kept in the user space 102 and not seen in the model space 104 and the predicted outputs 114 are computed in the user space 102. The user space 102 and the model space 104 are in separate execution environments. In one aspect, the execution environments may be separate computing devices interconnected by a network 103, where one computing device represents the user space and a distinct computing device represents the model space. In another aspect, the execution environments may be in separate virtual machines that reside on a same computing device where the virtual machines are isolated from each other and where there is no sharing of computing resources or data.

The system 100 shown in FIG. 1 shows three data flows to fine-tune a model. In a forward pass 116, the model is trained on the training dataset and the predicted output is generated and compared to a ground truth output 120. A cost function component 122 calculates a penalty for any deviation between the predicted output 114 and the ground truth output 120. In the backward pass or backpropagation pass 118, the partial derivatives of the loss function are calculated for each trainable weight of each layer of the model and the neural network of the linear layer 134 in the output layer 110. The last pass is the weight update pass 124 where select weights and biases of the layers of model, the embedding layer 106, and output layer 110 are adjusted by these partial derivatives.

The weights and biases (i.e., parameters) are adjusted based on a select customization approach. In a custom fine-tuning approach, all the model parameters are tuned. In the L-EO customization approach, most of the model's parameters are frozen and only the embedding 106 and output layer 110 parameters are fine-tuned. In the L-LDB customization approach, most of the model's parameters are frozen and only the parameters of the last decoder block are updated which includes the parameters of the self-attention layer, the encoder-decoder attention layer, the layer normalization and the feed forward layer.

The input layer 106 is the embedding layer of the model. The input or embedding layer turns words into their corresponding embeddings. An embedding is a learned representation for the text-based tokens/subtokens where a token/subtoken that has a common meaning is given a common representation. An embedding is a mapping of discrete categorical variables to a vector of continuous numbers. There is an embedding for each subtoken in the vocabulary and a corresponding positional embedding.

The embeddings are generated by the encoder blocks of the model from the input sequences used to train and fine-tune the model. The embedding store 130 contains the subtoken embedding matrix, Ws, and the positional embedding matrix, Wp, 125 generated by the model. The subtoken embedding matrix contains a vector for each token/subtoken in the model's vocabulary. The size of the subtoken embedding matrix is the vocabulary size multiplied by the embedding dimension. The embedding dimension is the size of the vector of real numbers that represents each unique token/subtoken. The model during training finds the optimal mapping of each of the unique tokens/subtokens to a vector of real numbers and the optimal size of the subtoken and positional embedding matrix.

Neural transformer models rely on positional embeddings to model the dependency between the tokens/subtokens at different positions in a sequence. A positional embedding encodes the absolute positions from 1 to the maximum sequence length T. Each position has a learnable embedding vector that represents how a token/subtoken at one position attends to another token in a different position. The positional embedding matrix is generated by the model and stored in the embedding store 130.

The input layer 106 includes the custom data 112 that is used to fine-tune a model, an encoder 126, an embedding engine 128, and an embedding store 130. The custom data 112 includes source code files from which source code snippets are extracted to fine-tune the model for a particular related task. The custom data contains the raw data of a user (i.e., developer, customer, client) that may need to be kept private due to the privacy concerns of the user or due to privacy laws or regulations.

In an aspect where the model is a sequence-to-sequence neural transformer model, the input training data consists of a pairs of source code snippets, where one part of the pair is a source code snippet of a first domain and the second part of the pair is a corresponding source code snippet of the second domain. The source code snippet of the first domain is transformed into a sequence of tokens representing the sequence of the first domain, X={x₁, . . . x_{T}}, and the source code snippet of the second domain is transformed into an ordered sequence of tokens representing the sequence of the second domain Y={y₁, . . . , y_{T}}, where T is the sequence length.

Each source code snippet is parsed into a parse tree or concrete syntax tree. An encoder 126, such as a byte-level byte-pair encoder, is used to extract T-ordered sequences of source code tokens or subtokens from the concrete syntax tree, where Tis the maximum content length. Some tokens may be split into subtokens that are subunits of a token that appear frequently in other tokens. In one aspect, byte-level byte-pair encoding (BPE) is used to generate the vocabulary used by the neural transformer model with attention.

The embedding engine 128 maps the T-ordered sequences of subtokens into numeric vectors and then into respective subtoken embeddings and positional embeddings. During training, the subtoken embeddings and corresponding positional embeddings of the source code snippet of the first domain are added to form a context tensor that is applied to the first encoding layer of the model. The subtoken embeddings and corresponding positional embeddings of the source code snippet of the second domain are added to form a context tensor that is applied to the first decoding layer of the model during training.

The model space 104 includes an execution environment which is separate from the user space and is where the neural transformer model operates. The model space 104 includes a fine-tuning engine 136 that applies the tuning dataset 127 to the pre-trained neural transformer model 108 performing the forward pass 116, backward pass 118, and weight update 124. In an aspect, the model 108 is composed with a number of encoder blocks 140a-140n (“140”) and a number of decoder blocks 138a-138n (“138”).

The model space may be part of a web service that offers access to a pre-trained neural transformer model for fine-tuning the model for a particular related task. In one aspect, the pre-trained model is trained on natural language text and source code snippets from various source code files from the same programming language. The model has been previously trained and includes learned subtoken and positional embeddings from the pre-trained datasets.

The output of the model is a vector of floating-point numbers or set of hidden states 132 from the last decoder block of the pre-trained neural transformer model 108 which is transmitted to the output layer 110 of the user space 102. The output layer 110 includes a linear layer 134 and a softmax layer 136 that generates the predicted output 114. The linear layer 134 is a feed forward neural network that projects the vector of floating-point numbers of the hidden states into a logits vector. The logits vector is then input to the softmax layer 136 which generates a probability distribution for all the tokens in the model's vocabulary.

The softmax layer 136 performs a softmax function to normalize the output of the model into a probability distribution over the tokens/subtokens in the model's vocabulary. The softmax function takes as input a vector z of K real numbers, and normalizes it into a probability distribution consisting of K probabilities proportional to the exponentials of the input numbers. The softmax function applies the standard exponential function to each element of the input vector and normalizes these values by dividing the sum of these exponentials thereby ensuring that the sum of the output vector is 1. In one aspect, the softmax function σ may be represented mathematically as follows:

$$σ : {ℝ}^{K} - > {[ 0 , 1 ]}^{K} , {σ ( z )}_{i} = \frac{{e}^{{z}_{i}}}{{\sum }_{j = 1}^{k} {e}^{{z}_{j}}} , \\ for i = 1 , … K and z = ( {z}_{1} , … , {z}_{K} ) ∈ {ℝ}^{K} .$$

The output of the softmax function is the output probabilities for each token/subtoken in the model's vocabulary 114.

The cost function component 122 estimates the loss or error which is used to compare how good or bad the predicted results Y′ are compared with the ground truth, X 120. The aim of the model fine-tuning is to minimize the cross-entropy loss by iteratively adjusting the model weights. In one aspect, a categorical cross-entropy loss function is used.

Once the loss is calculated as being unacceptable or meeting a loss threshold, it is propagated backwards to the hidden layers that contributed directly to the output which are both in the user space 102 and the model space 104. When the loss is calculated as being acceptable or meeting a success threshold, the predicted output is released.

In backpropagation (i.e., backward pass 118), the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. Thereafter, the weights are updated according to the selected customization strategy. A backpropagation through time (BPTT) algorithm may be used to update the weights.

Attention now turns to a more detailed description of the neural transformer model with attention.

Neural Transformer Model

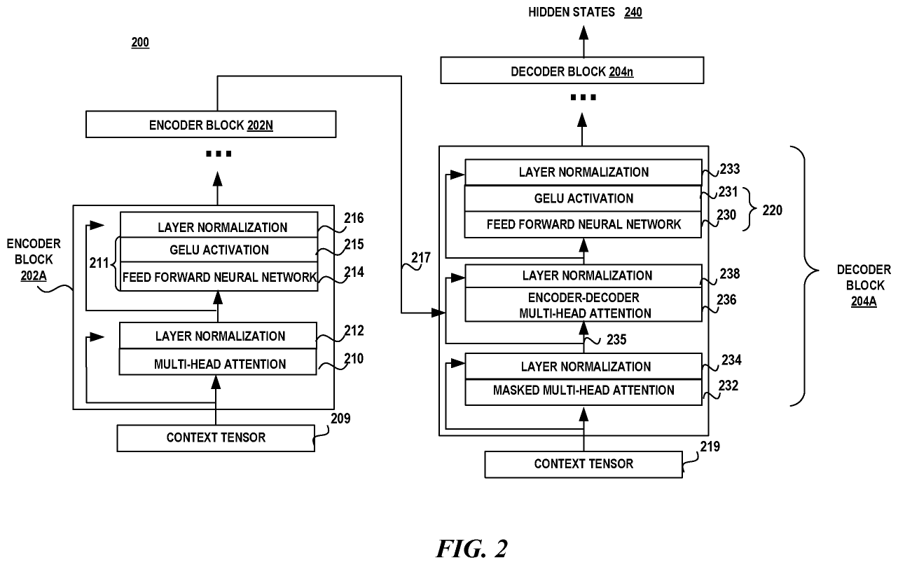

FIG. 2 shows an exemplary structure of the neural transformer model with attention in an encoder-decoder configuration for fine-tuning.

The neural transformer model with attention 200 contains one or more encoder blocks 202A-202N (“202”) and one or more decoder blocks 204A-204N (“204”). A tuning dataset consists of a pair of context tensors 209, 219. The first encoder block 202A receives the context tensor 209 representing an input sequence in a first domain and the first decoder block 204A receives a context tensor 219 representing the translated sequence in a second domain.

An encoder block 202 consists of two layers. The first layer includes a multi-head attention component 210 followed by layer normalization component 212. The second layer includes a feed-forward neural network 214 followed by a Gaussian Error Linear Unit (GELU) activation layer 215 and then a layer normalization component 216. The context tensor 209 is input into the multi-head attention layer 210 of the encoder block 202 with a residual connection to layer normalization 212. The output of the layer normalization 212 is input to the feed forward neural network 214 with another residual connection to layer normalization 216. The output of an encoder block 202 is a set of hidden representations. The set of hidden representations 217 is then sent through additional encoder blocks, if multiple encoder blocks exist. The hidden representations 217 of the last encoder block 202N are sent to the first decoder block 204A.

Attention is used to decide which parts of the input sequence are important for each subtoken, especially when decoding long sequences since the encoder is limited to encoding a fixed-size vector. Attention mechanisms gather information about the relevant context of a given subtoken and then encode that context into a vector which represents the subtoken. It is used to identity the relationships between subtokens in the long sequence while ignoring other subtokens that do not have much bearing on a given prediction.

The multi-head attention component 210 takes a context tensor 209 and weighs the relevance of each subtoken represented in the context tensor 209 to each other by generating attention weights for each subtoken in the context tensor 209. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries Q and keys K of dimension dₖ, and values V of dimension dᵥ. Q is a matrix that contains the query or vector representation of one subtoken in a sequence, K is the vector representations of all subtokens in the sequence, and Vis the vector representations of all the subtokens in the sequence.

The queries, keys and values are linearly projected h times in parallel with dᵥ output values which are concatenated to a final value:

MultiHead(Q,K,V)=Concat(head₁,headₕ)W^{o},

where headᵢ=Attention(QWᵢ^{Q},KWᵢ^{K},VWᵢ^{v}),

with parameter matrices Wᵢ^{Q}ϵ [symbol] ^{d}^{_{model}}^{×d}^{ₖ}, Wᵢ^{K}ϵ [symbol] ^{d}^{_{model}}^{×d}^{ₖ}, Wᵢ^{V}ϵ [symbol] ^{d}^{_{model}}^{×d}^{ₖ}, and W^{O}ϵ [symbol] ^{hd}^{ᵥ}^{×d}^{_{model}}, where Wᵢ^{Q} are the query weights, Wᵢ^{K} are the key weights, Wᵢ^{V} are the value weights, and W^{O} are the weights of the concatenated output. Hence, the weights of the multi-head attention layer 210 are the parameter matrices, Wᵢ^{Q}, Wᵢ^{K}, Wᵢ^{V}, W^{O}.

In order to reduce the training time of the neural transformer, layer normalization is used between the layers. The layer normalization component normalizes the inputs across the features. The mean and standard deviation is computed across the feature dimensions. There is a first layer normalization 212 that precedes the feed forward neural network 214 and a second layer normalization 216 that follows the feed forward neural network 214.

The GELU is an activation function that scales the output of the feed-forward neural networks for the layer normalization layer. The GELU is defined as follows: GELU(x)=0.5x (1+tanh (\sqrt{2}/π(x+0.044715x³))). The GELU activation function is used to achieve faster and better convergence that a sigmoid function and to avoid the vanishing gradient problem.

The output of the top encoder block is a set of attention vectors K and V 217 which is used by the encoder-decoder multi-head attention layer 236 of the decoder block 204.

The decoder block 204 predicts each subtoken tᵢ in the target language one-by-one at each time step conditioned on all previously-generated target subtokens t₁, . . . tᵢ₋₁. The decoder block 204 consists of three layers. The first layer includes a masked multi-head attention component 232 followed by a layer normalization component 234. The output of the layer normalization component 234 is input into the encoder-decoder multi-head attention component 236 with a residual connection 235 to layer normalization component 238. The second layer includes an encoder-decoder multi-head attention component 236 followed by a layer normalization component 238. The output of layer normalization component 238 is input into the feed forward neural network 230 with a residual connection to layer normalization component 233. The third layer includes a feed forward neural network 230 followed by GELU activation 231 and then a layer normalization component 233.

The masked multi-head attention component 232 receives the output embeddings of the previous timestep. The masked multi-head attention component 232 masks the output embeddings from future time steps. The encoder-decoder multi-head attention layer 236 receives queries from the previous decoder layer 325 and the memory keys and values 217 from the output of the encoder block 202. In this manner, the decoder block 204 can attend to every position of the input sequence. The feed-forward neural network 230 processes each output encoding separately. A layer normalization component 234, 238, 233 is used between the layers in order to normalizes the inputs across the features.

Parameter Updating

The training of a neural transformer model is a process where the model learns which weights and biases (i.e., parameters) minimize a cost function which results in a better fitting model. The weights and biases are used in various layers of the encoder and decoder blocks and the layers of the output layer.

Referring to FIGS. 1 and 2, the embedding layer 106 generates an input sequence of embeddings 127 that are applied to the pre-trained model. Given an input sequence of tokens X, the embedding layer 106 converts the input sequence into an embedding input tensor H⁰ϵ [symbol] ^{|X|×dh}, where |X| is the input sequence length and dₕ is the embedding dimension. Each row j of H⁰ is obtained is obtained as H⁰ⱼ=EmbeddingLookupₜₒₖₑₙ (xⱼ, V) EmbeddingLookupₚₒₛᵢₜᵢₒₙ (j, P), where EmbeddingLookupₜₒₖₑₙ is performed by the embedding engine 128 to search in the embedding store 130 for the embedding of subtoken xⱼ, where EmbeddingLookupₚₒₛᵢₜᵢₒₙ is performed by the embedding engine 128 to search in the embedding store 130 for the embedding of position j, where Vis the subtoken vocabulary, xᵢ is a subtoken at position j of the input sequence, and P is the maximum sequence length or the maximum number of positions in a sequence. EmbeddingLookupₜₒₖₑₙ (xⱼ, V) returns the dimensional row, dₕ, of the embedding matrix Ws that corresponds to xⱼ and EmbeddingLookupₚₒₛᵢₜᵢₒₙ (j, P) returns the dimensional row of the embedding matrix Wp that corresponds to the position j.

The model applies n transformer blocks (i.e., encoder and decoder blocks) over the input embeddings to produce contextual representations: Hⁿ=transformerₙ (Hⁿ⁻¹), nϵ[1, N].

Each transformer block includes a multi-headed self-attention layer followed by a feed forward neural network (i.e., multi-layer perceptron MLP). Each of these layers is followed by skip-connection and layer normalization operation, LayerNorm. Specifically, for the n-th transformer block:

Gⁿ=LayerNorm(MultiHeadAttn(Hⁿ⁻¹)+Hⁿ⁻¹

Hⁿ=LayerNorm(FeedForward(Gⁿ)+Gⁿ)

where MultHeadAttn is operation of the multi-head self-attention layers 210, 232, 236, and FeedForward is the operation of the feed forward neural network layers 214, 230, and LayerNorm is the operation of the layer normalization layers 212, 216, 234, 233.

For the n-th transformer layer, the multi-headed self-attention is parameterized with matrices Wᵢ^{Q}, Wᵢ^{K}, Wᵢ^{V}ϵR^{dh×dk}, which are used to linearly project the Hⁿ⁻¹ to obtain query, key and value matrices:

Qᵢ=Hⁿ⁻¹*Wᵢ^{Q},Kᵢ=Hⁿ⁻¹*Wᵢ^{K},Vᵢ=Hⁿ⁻¹*Wᵢ^{V}.

The output of the multi-head attention operation is obtained as:

$${head}_{i} = softmax ( \frac{{Q}_{i} {K}_{i}^{T}}{\sqrt{{d}_{K}}} + M ) {V}_{i} ,$$

Gⁿ=[head₁,head₂, . . . headᵤ]Wₙ^{O},

where the previous layer's output Hⁿ⁻¹ϵ [symbol] ^{|X|×dh} is linearly projected to a triplet of queries, keys, and values using model parameters Wᵢ^{Q}, Wᵢ^{K}, Wᵢ^{V}ϵR^{dh×dh}, respectively, where u is the number of self-attention heads, dₖ is the dimension of a head, and Wₙ^{O}ϵ [symbol] ^{dh×dh} are the model parameters, where Mϵ [symbol] ^{dh×dh} is a mask matrix, where [ . . . ] represents a concatenation operation.

Gⁿ serves as input to a multilayer perception (“MLP”) 211, 220 which includes a feed forward neural network layer 214, 230 and a GELU activation layer 215, 231. MLP 211, 220 performs the computation Zⁿ=W₂^{T} GELU (W₁^{T}+b₁)+b₂, where W₁γ [symbol] ^{dh×dh}, W₂ϵ [symbol] ^{4dh×dh} are weight matrices parametrizing the MLP.

The output of the MLP layer which is also the output of an encoder block and decoder block is obtained by applying the skip-connection and layer normalization operation:

Hⁿ=LayerNorm(Zⁿ+Gⁿ),

where the LayerNorm function is defined as:

$$LayerNorm ( {Z}^{n} , γ , β ) = γ \frac{{Z}^{n} - {u}_{{z}^{n}}}{{σ}_{{z}_{n}}} + β , where γ , β ϵ {ℛ}^{d} , \\ and where {μ}_{{Z}^{n}} = \frac{1}{k} {\sum }_{i = 1}^{k} {Z}_{i}^{n} , \\ and where {σ}_{{Z}^{n}} = \sqrt{\frac{1}{k} {\sum }_{i = 1}^{k} {( {Z}_{i}^{n} - {μ}_{{Z}^{n}} )}^{2}} .$$

The tuning of the feed forward neural network 214, 230, consists of the forward pass, loss calculation [symbol] , backward pass to extract the gradient of the loss function ∇ [symbol] over the trainable parameters via chain-rule differentiation and the weight update. The weight update is performed using the standard stochastic gradient descent formulation:

W^{k}=Wₖ₋₁−λ∇ [symbol] (W^{k-1}).

Attention now turns to a more detailed description of the various fine-tuning approaches.

Fine-Tuning the Neural Transformer Model with Attention

In the customization fine-tuning, where all the parameters of the model are recalculated, these parameters include the embeddings, Wp and Ws, computed by the encoder blocks of the model, the weights and biases in the multi-head self-attention layer of the encoder and decoder blocks, and encoder-decoder attention layer, the weights and biases in the layer normalization of the encoder and decoder blocks, weights and biases in the feed-forward neural networks of the encoder and decoder blocks, weights and biases of the masked multi-head attention layer of the decoder blocks, the weights and biases of the encoder-decoder multi-head attention layer of the decoder blocks, and the weights and biases for the linear layer of the output layer.

For the L-EO customization approach, the embeddings, Ws, Wp, and the weights and biases of the linear layer of the output layer. For the L-LDB customization approach, the weights and biases of the last decoder block are updated which include the attention weights,

$${W}_{i}^{Q} ∈ {ℝ}^{{d}_{m o d e l} x {d}_{k}} , \\ {W}_{i}^{K} ∈ {ℝ}^{{d}_{m o d e l} x {d}_{k}} , \\ {W}_{i}^{V} ∈ {ℝ}^{{d}_{m o d e l} x {d}_{k}} , \\ and {W}^{O} ∈ {ℝ}^{h {d}_{v} x {d}_{m o d e l}} ,$$

in the masked multi-head attention layer and the encoder-decoder multi-head attention layer, the weights and biases in the feed-forward neural network, and the weights and biases in the layer normalization layers.

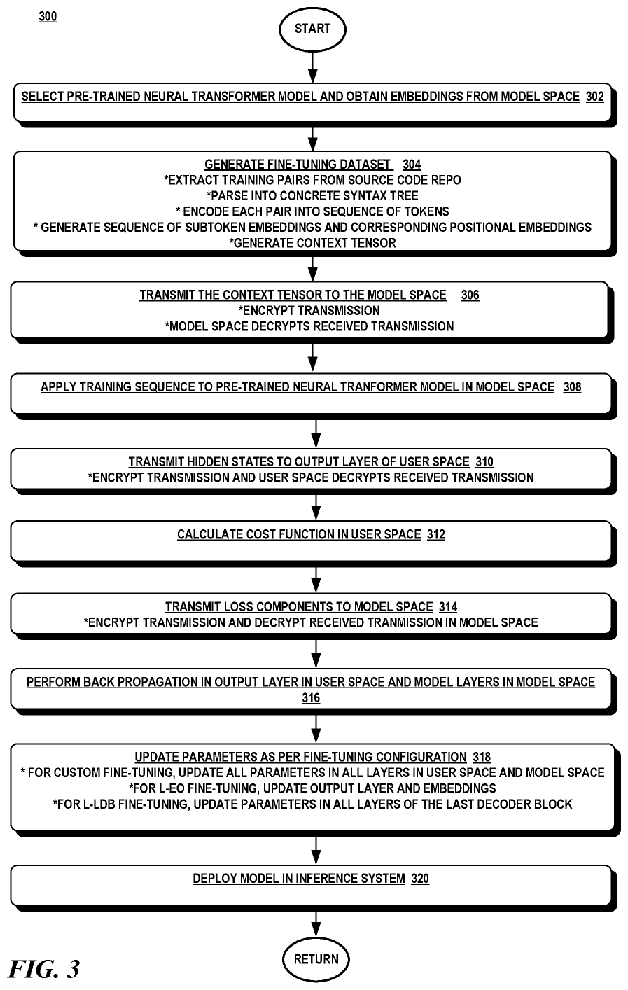

Turning to FIG. 3, there is shown an exemplary method 300 for fine-tuning a neural transformer model with attention. Initially, a particular pre-trained model is selected and the pre-trained subtoken and positional embeddings, Ws and Wp, of the model are obtained from the model space and stored in the embedding store of the user space (block 302).

The fine-tuning dataset is then generated. The fine-tuning dataset consists of pairs of input sequences, wherein one part of the pair includes an input sequence of a first domain and the second part of the pair includes its corresponding translated sequence in a second domain. The sequences represent source code components, such as a source code method body, method docstring, method signature, unit test case, source code bug patch, and the like. Each input sequence of the pair is parsed into a concrete syntax tree from which a sequence of tokens is extracted and encoded into subtokens. Each token/subtoken in the sequence is replaced with its respective subtoken embedding from the pre-trained embeddings and a positional embedding is generated for each subtoken embedding. A context tensor is formed by combining the sequence of subtoken embedding with its corresponding positional embeddings. (Collectively, block 304).

The context tensor is then transmitted to the model space. In one aspect, the context tensor is encrypted before it is transmitted to the model space. The encryption method may employ any type of symmetric or asymmetric technique such as, without limitation, Advanced Encryption Standard (AES), Rivest-Shamir-Adleman (RSA), triple DES (Data Encryption Standard), Twofish, or the like. (Collectively, block 306).

The context tensor is then applied to fine-tune the pre-trained neural transformer model in the model space. In one aspect, a fine-tuning dataset consists of a large number of pairs of context tensors that are partitioned into smaller batches. The training is iterative with each batch running through the fine-tuning process. The entire batch is passed through each of the encoder and decoder blocks of the pre-trained neural transformer model in multiple iterations. Each training iteration includes forward propagation, loss calculation, backpropagation steps followed by updating the weights. (Collectively, block 308).

The first encoder block of the neural transformer model takes the first context tensor of a pair as input and passes it through the multiple layers of multi-head attention, layer normalization, feed-forward neural network, GELU activation, and layer normalization to finally produce a set of hidden representations. If there are additional encoder blocks, the output of each encoder block is passed onto the next encoder block with the output of the last encoder block producing the set of hidden representations. The set of hidden representations is passed onto each decoder block. (Collectively, block 308).

The first decoder block of the model takes the second context tensor of the pair as input and passes it to the masked multi-head attention layer. Starting with the first token of the context tensor, the subtokens are passed through the self-attention and normalization layers and into the encoder-decoder attention layer, serving as the query for encoder-decoder attention, where the key and value pairs for the attention are the outputs of the last encoder block. (Collectively, block 308).

The feed forward neural networks in the encoder blocks and the decoder blocks are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a categorical cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 308).

At the completion of each batch, the parameters of the neural transformer model are updated at a preconfigured frequency. The parameters include the weights and biases at each encoder and decoder layer which includes subtoken embeddings and the positional embeddings which are stored in a respective embedding matrix. (Collectively, block 308).

The model outputs the hidden states of the last decoder block which are transmitted to the linear layer in the user space. In one aspect, the hidden states are encrypted before being transmitted to the user space. The linear layer includes a fully connected neural network that transforms the hidden states into a larger vector, called logits vector, that has the same dimensions of the vocabulary size. Each value of the logit vector represents the score for each unique word in the vocabulary. Next, a standard softmax function is applied to the logits vector, to obtain a new vector, with same dimensions, where scores are converted into probabilities. Specifically, each score is transformed into a positive numerical value, such that the summation of all the values, along the entire vector, summed up to 1.0 These probabilities are used to select the next token/subtoken in the generated sentence. (Collectively, block 310).

In an aspect, the cross-entropy loss is computed as follows: [symbol] (Θ)=−Σᵢ₌₁^{K} yᵢ log (y′ᵢ), where yᵢ is the ground truth token/subtoken at position i and y′ᵢ is the predicted token/subtoken at position i, K is the number of tokens/subtoken output. (Collectively, block 312).

When the error loss exceeds a threshold, the components of the loss calculation are transmitted to the output layer and to the model space. The error loss calculation components include the identity of the loss function algorithm, the predicted output Y′, and the ground truth X. When the loss is within acceptable bounds of the threshold, the fine-tuning process ends (Collectively, block 314).

The output layer and the model each use the error loss calculation components to perform backpropagation where the gradients of the loss function are calculated with respect to the weights of each respective layer (block 316). The weights at each layer are updated in accordance with the selected customization strategy (block 318). The process in blocks 310 through block 318 are performed for each batch of training sequences.

Upon completion of the fine-tuning process, the custom model is then deployed in an inference system that generates source code. In one aspect, the model may be deployed in a web service or application that generates test cases given a context (e.g., method signature, docstring or method body). In another aspect, the model may be part of a source code editor or integrated development environment (“IDE”). The IDE may utilize a function where the model is utilized to generate a unit test cases automatically upon initiation of a particular user input. In another aspect, the model may be part of an application that generates unit test cases for source code that is uploaded into a source code repository. (Collectively, block 320).

Exemplary Operating Environment

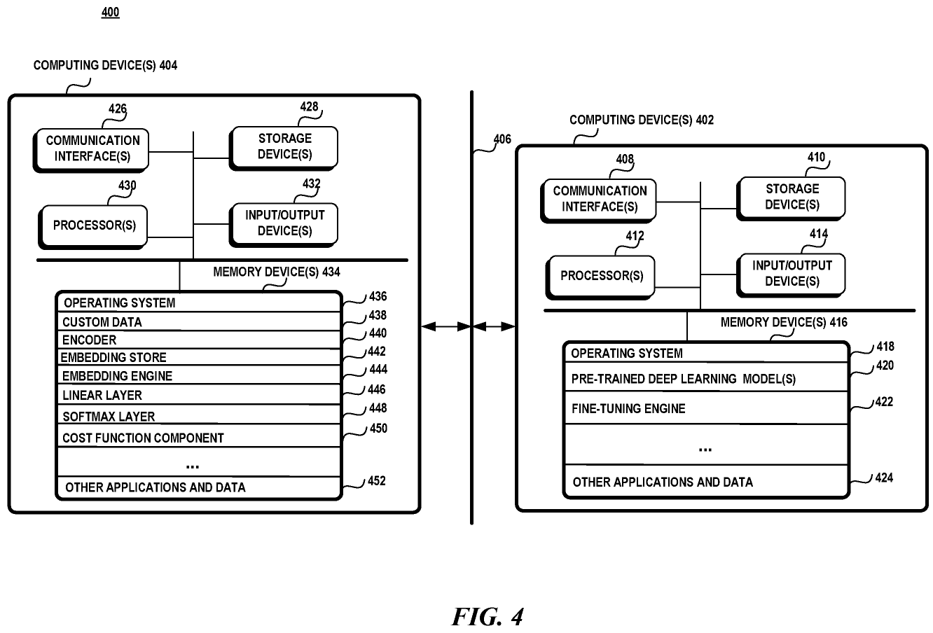

Attention now turns to a discussion of an exemplary operating environment. FIG. 4 illustrates an exemplary operating environment 400 in which one or more computing devices 402, 404 are used in a custom model development system. In one aspect, the fine-tuning of the deep learning model and the usage of the model may be performed on a single device. However, it should be noted that the aspects disclosed herein are not constrained to any particular configuration of devices.

In alternate embodiments, the development system may be configured as a cloud service that fine-tunes a pre-trained deep learning model as a service. A client device 404 may transmit to the cloud service 402 the fine-tuning datasets for the service to apply to the pre-trained deep learning model with the interactions between the model and the client device described above. Other variations are possible and it should be noted that the operating environment is not limited to any particular configuration.

A computing device 402, 404 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1300 may be configured in a network environment, a distributed environment, a multi-processor environment, or a stand-alone computing device having access to remote or local storage devices.

A computing device 402, 404 may include one or more processors 412, 430, one or more communication interfaces 408, 426, one or more storage devices 410, 428, one or more input/output devices 414, 432, and one or more memory devices 416, 434. A processor 412, 430 may be any commercially available or customized processor and may include dual microprocessors and multi-processor architectures. A communication interface 408, 426 facilitates wired or wireless communications between the computing device 402, 404 and other devices. A storage device 410, 428 may be computer-readable medium that does not contain propagating signals, such as modulated data signals transmitted through a carrier wave. Examples of a storage device 410, 428 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 410, 428 in a computing device 402, 404. The input/output devices 414, 432 may include a keyboard, mouse, pen, voice input device, touch input device, display, speakers, printers, etc., and any combination thereof.

A memory device 416, 434 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 416, 434 may also include one or more external storage devices or remotely located storage devices that do not pertain to propagated signals, such as modulated data signals transmitted through a carrier wave.

The memory device or memory 416, 434 may contain instructions, components, and data. A component is a software program that performs a specific function and is otherwise known as a module, program, component, and/or application. Memory device 416 may include an operating system 418, one or more pre-trained deep learning models 420, a fine-tuning engine 422, and other applications and data 424. Memory device 434 may include an operating system 436, custom data 438, an encoder 440, an embedding store 442, an embedding engine 444, a linear layer 446, a softmax layer 448, a cost function component 450, and other applications and data 452.

The computing devices 402, 404 may be communicatively coupled via a network 406. The network 406 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 406 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

The subject matter disclosed pertains to a mechanism for tuning an existing deep learning model to perform a related downstream task in a manner that minimizes the computing resources used in the fine-tuning process. The process updates select parameters of the previously trained model thereby creating a custom model having a smaller size and readily with less computing resources. This results in the custom model using less computing resources during inference. In addition, the process of generating a custom deep learning model is performed in a manner that preserves the integrity and privacy of the raw user data and the output predictions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

A system is disclosed comprising: a processor; and a memory. The memory stores a program configured to be executed by the processor. The program including instructions to perform acts that: receive from a user space, through a network, a fine-tuning dataset to fine-tune a pre-trained sequence-to-sequence deep learning model, wherein the pre-trained sequence-to-sequence deep learning model is pre-trained to generate source code given a context, wherein the pre-trained sequence-to-sequence deep learning model includes at least one encoder block and at least one decoder block without an input embedding layer and without an output layer, wherein the pre-trained deep learning model including a plurality of layers, each layer including a set of parameters; generate a predicted output from application of the fine-tuning dataset to the pre-trained sequence-to-sequence deep learning model; transmit the predicted output through the network to the user space; receive from the user space, an error associated with a difference between the predicted output and a ground truth output; backpropagate the error to each layer of the plurality of layers of the pre-trained deep learning model; update the set of parameters of select ones of the plurality of layers of the pre-trained deep learning model based on the backpropagated error; and upon completion of the application of the fine-tuning dataset, deploy the custom model in an inference system.

In an aspect, the program includes instructions to perform acts that: update the set of parameters of each of the plurality of layers of the pre-trained deep learning model; update only the set of parameters of each of the plurality of layers of a last decoder block of the pre-trained deep learning model; or update only embeddings derived from the at least one encoder block. The updated embeddings to the user space.

In an aspect, the program includes instructions to perform acts that: encrypt the updated embeddings prior to transmission to the user space and encrypt the predicted output prior to transmission to the user space.

In an aspect, the program includes instructions to perform acts that: decrypt the fine-tuning dataset received from the user space and decrypt the error received from the user space.

A computer-implemented method is disclose, comprising: configuring a pre-trained sequence-to-sequence neural transformer model having an embedding layer, a transformer block and an output layer into a user space and a model space, wherein the user space and the model space are in separate execution environments, wherein the user space includes the embedding layer and the output layer, wherein the model space includes the transformer block, wherein the transformer block includes at least one encoder block and at least one decoder block, wherein the at least one encoder block includes a plurality of encoder layers, wherein the at least one decoder block includes a plurality of decoder layers, wherein the pre-trained sequence-to-sequence neural transformer model includes pre-trained embeddings, wherein the pre-trained sequence-to-sequence neural transformer model generates source code; receiving from the user space, a tuning dataset for a downstream task, wherein the tuning dataset includes sequences of input embeddings based on the pre-trained embeddings; tuning the pre-trained sequence-to-sequence neural transformer model with the tuning dataset to create a custom model, wherein the pre-trained sequence-to-sequence neural transformer model generates a predicted output from application of the training dataset; transmitting the predicted output to the user space; receiving from the user space a loss computation indicating a loss error between the predicted output and a corresponding ground truth output; backpropagating the loss error to the transformer block; updating parameters of select ones of the plurality of encoder layers and parameters of select ones of the plurality of decoder layers based on the loss error; and upon completion of the tuning, deploying the custom model in an inference system.

In an aspect, updating parameters of select ones of the plurality of encoder layers and parameters of select ones of the plurality of decoder layers based on the loss error further comprises: updating parameters of each of the plurality of encoder layers and updating parameters of each of the plurality of decoder layers.

In an aspect, updating parameters of select ones of the plurality of encoder layers and parameters of select ones of the plurality of decoder layers based on the loss error further comprises: updating only parameters of the plurality of layers of a last decoder block; or updating only parameters of the plurality of layers of the at least one encoder block to generate updated embeddings.

In an aspect, the updated embeddings encrypted prior to transmission to the user space. In an aspect, transmitting the output to the user space further comprises: encrypting the output prior to the transmission.

In an aspect, the custom model learns to generate source code of a target domain given source code of a first domain. The first domain includes a method signature and the target domain includes a unit test case, the first domain includes a method body and the target domain includes a unit test case, or the first domain includes a docstring and the target domain includes a unit test case.

A computer-implemented method is disclosed, comprising: accessing a pre-trained neural transformer model to fine-tune for a source code generation task; obtaining pre-trained embeddings of the pre-trained neural transformer model; generating input sequences for a custom dataset from the pre-trained embeddings; transmitting the input sequences through a network to a web service, wherein the web service fine-tunes the pre-trained neural transformer model with the input sequences; receiving, from the web service through the network, a predicted output from application of the input sequences of embeddings to the pre-trained neural transformer model; computing an error loss from the predicted output and a ground truth output; upon the error loss exceeding a loss threshold, transmitting error loss components back to the web service for backpropagation of the error loss to the pre-trained neural transformer model; and upon the error loss meeting a success threshold, deploying the fine-tuned neural transformer model in an inference system.

In an aspect, the computer-implemented method further comprises: receiving updated embeddings from the web service upon the backpropagation of the error loss to the pre-trained neural transformer model. In an aspect, the computer-implemented method, further comprises: prior to transmitting the input sequences through the network to the web service, encrypting the input sequences. In an aspect, the computer-implemented method of claim 17, further comprises: prior to transmitting the error loss components back to the web service, encrypting the error loss components.

What is claimed:

1. A system comprising:
a processor; and
a memory that stores a program configured to be executed by the processor, the program including instructions to perform acts that:
receive from a user space, through a network, a fine-tuning dataset to fine-tune a pre-trained sequence-to-sequence deep learning model, wherein the pre-trained sequence-to-sequence deep learning model is pre-trained to generate source code given a context, wherein the pre-trained sequence-to-sequence deep learning model includes at least one encoder block and at least one decoder block without an input embedding layer and without an output layer, wherein the pre-trained deep learning model including a plurality of layers, each layer including a set of parameters;
generate a predicted output from application of the fine-tuning dataset to the pre-trained sequence-to-sequence deep learning model;
transmit the predicted output through the network to the user space;
receive from the user space, an error associated with a difference between the predicted output and a ground truth output;
backpropagate the error to each layer of the plurality of layers of the pre-trained deep learning model;
update the set of parameters of select ones of the plurality of layers of the pre-trained deep learning model based on the backpropagated error; and
upon completion of the application of the fine-tuning dataset, deploy the custom model in an inference system.

2. The system of claim 1, wherein the program includes instructions to perform acts that:
update the set of parameters of each of the plurality of layers of the pre-trained deep learning model.

3. The system of claim 1, wherein the program includes instructions to perform acts that:
update only the set of parameters of each of the plurality of layers of a last decoder block of the pre-trained deep learning model.

4. The system of claim 1, wherein the program includes instructions to perform acts that:
update only embeddings derived from the at least one encoder block; and
transmit the updated embeddings to the user space.

5. The system of claim 4, wherein the program includes instructions to perform acts that:
encrypt the updated embeddings prior to transmission to the user space.

6. The system of claim 1, wherein the program includes instructions to perform acts that:
encrypt the predicted output prior to transmission to the user space.

7. The system of claim 1, wherein the program includes instructions to perform acts that:
decrypt the fine-tuning dataset received from the user space.

8. The system of claim 1, wherein the program includes instructions to perform acts that:
decrypt the error received from the user space.

9. A computer-implemented method, comprising:
configuring a pre-trained sequence-to-sequence neural transformer model having an embedding layer, a transformer block and an output layer into a user space and a model space, wherein the user space and the model space are in separate execution environments, wherein the user space includes the embedding layer and the output layer, wherein the model space includes the transformer block, wherein the transformer block includes at least one encoder block and at least one decoder block, wherein the at least one encoder block includes a plurality of encoder layers, wherein the at least one decoder block includes a plurality of decoder layers, wherein the pre-trained sequence-to-sequence neural transformer model includes pre-trained embeddings, wherein the pre-trained sequence-to-sequence neural transformer model generates source code;
receiving from the user space, a tuning dataset for a downstream task, wherein the tuning dataset includes sequences of input embeddings based on the pre-trained embeddings;
tuning the pre-trained sequence-to-sequence neural transformer model with the tuning dataset to create a custom model, wherein the pre-trained sequence-to-sequence neural transformer model generates a predicted output from application of the training dataset;
transmitting the predicted output to the user space;
receiving from the user space a loss computation indicating a loss error between the predicted output and a corresponding ground truth output;
backpropagating the loss error to the transformer block;
updating parameters of select ones of the plurality of encoder layers and parameters of select ones of the plurality of decoder layers based on the loss error; and
upon completion of the tuning, deploying the custom model in an inference system.

10. The computer-implemented method of claim 9, wherein updating parameters of select ones of the plurality of encoder layers and parameters of select ones of the plurality of decoder layers based on the loss error further comprises:
updating parameters of each of the plurality of encoder layers and updating parameters of each of the plurality of decoder layers.

11. The computer-implemented method of claim 9, wherein updating parameters of select ones of the plurality of encoder layers and parameters of select ones of the plurality of decoder layers based on the loss error further comprises:
updating only parameters of the plurality of layers of a last decoder block.

12. The computer-implemented method of claim 9, wherein updating parameters of select ones of the plurality of encoder layers and parameters of select ones of the plurality of decoder layers based on the loss error further comprises:
updating only parameters of the plurality of layers of the at least one encoder block to generate updated embeddings.

13. The computer-implemented method of claim 12, further comprises:
transmitting the updated embeddings encrypted to the user space.

14. The computer-implemented method of claim 9, wherein transmitting the output to the user space further comprises:
encrypting the output prior to the transmission.

15. The computer-implemented method of claim 9, wherein the custom model learns to generate source code of a target domain given source code of a first domain.

16. The computer-implemented method of claim 15,
wherein the first domain includes a method signature and the target domain includes a unit test case, the first domain includes a method body and the target domain includes a unit test case, or the first domain includes a docstring and the target domain includes a unit test case.

17. A computer-implemented method, comprising:
accessing a pre-trained neural transformer model to fine-tune for a source code generation task;
obtaining pre-trained embeddings of the pre-trained neural transformer model;
generating input sequences for a custom dataset from the pre-trained embeddings;
transmitting the input sequences through a network to a web service, wherein the web service fine-tunes the pre-trained neural transformer model with the input sequences;
receiving, from the web service through the network, a predicted output from application of the input sequences of embeddings to the pre-trained neural transformer model;
computing an error loss from the predicted output and a ground truth output;
upon the error loss exceeding a loss threshold, transmitting error loss components back to the web service for backpropagation of the error loss to the pre-trained neural transformer model; and
upon the error loss meeting a success threshold, deploying the fine-tuned neural transformer model in an inference system.

18. The computer-implemented method of claim 17, further comprising:
receiving updated embeddings from the web service upon the backpropagation of the error loss to the pre-trained neural transformer model.

19. The computer-implemented method of claim 17, further comprising:
prior to transmitting the input sequences through the network to the web service, encrypting the input sequences.

20. The computer-implemented method of claim 17, further comprising:
prior to transmitting the error loss components back to the web service, encrypting the error loss components.
